(19) United States
(12) Patent Application Publication
(10) Pub. No.: US 2010/0179792 A1
(43) Pub. Date: Jul. 15, 2010

(54) MONTE CARLO SIMULATION METHOD, SIMULATION APPARATUS, AND MEDIUM STORING SIMULATION PROGRAM

(75) Inventors: Takashi Kúrusu, Yokohama-shi (JP); Hiroyoshi Tanimoto, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/683,135

(22) Filed: Jan. 6, 2010

(30) Foreign Application Priority Data
Jan. 9, 2009 (JP) 2009-003675

(51) Int. Cl. G06F 17/11

(52) U.S. Cl. 703/2

(57) ABSTRACT

A Monte Carlo simulation method for simulating movement of a carrier by alternately repeating a scattering process and a drift process, includes calculating, as a scattering time, a relaxation time by a Drude's formula in the scattering process, and determining a state of a carrier after the scattering, on the basis of a distribution function of a thermal equilibrium state.

### CROSS-REFERENCE TO RELATED APPLICATIONS

This application is based upon and claims the benefit of priority from prior Japanese Patent Application No. 2009-003675, filed Jan. 9, 2009, the entire contents of which are incorporated herein by reference.

### BACKGROUND

A Monte Carlo method to analyze carrier transport in semiconductor devices is a method for exactly solving a semiclassical Boltzmann transport equation. This Monte Carlo method is recognized as a most precise one of device simulation methods. However, this method is not widely used since the calculation cost is high and implementation is difficult.

In the Monte Carlo method, the movement of a carrier is simulated by repeating scattering and drift motion, and the physical quantities relating to carrier transport, such as carrier mobility, is calculated (e.g. JP8-204178).

In order to perform a Monte Carlo simulation, it is thus necessary to theoretically study what kind of scattering takes place in a material that is the object of simulation, and to reflect the result of the study on a simulation program. In other words, it is necessary to extract all scattering mechanisms and to calibrate the parameters relating to the respective kinds of scatterings, on the basis of the comparison with theoretical calculations and experiments.

Since this series of procedures are very difficult, it is not easy to apply the Monte Carlo simulation to a material that its property is not well known. In addition to the above-described point, the calculation cost of the Monte Carlo method is generally high. This point is also a problem of the Monte Carlo simulation.

Under the circumstances, there has been a demand for a simulation method which can realize easy implementation and reduction in calculation cost, a simulation apparatus, and a program for executing this simulation method on a computer.

### SUMMARY

According to a first aspect of the invention, there is provided a Monte Carlo simulation method for simulating movement of a carrier by alternately repeating a scattering process and a drift process, comprising: calculating a scattering time by Drude's formula in the scattering process; and determining a state of a carrier after the scattering on the basis of a distribution function of a thermal equilibrium state.

According to a second aspect of the invention, there is provided a Monte Carlo simulation apparatus for simulating movement of a carrier by alternately repeating a scattering process and a drift process, comprising: an input unit configured to input initial values of parameters relating to scattering; a memory unit configured to store a simulation program, a calculation formula, a model formula of a device, the initial values of the parameters relating to scattering, which are input from the input unit, and an arithmetic result; an arithmetic unit configured to calculate as a scattering time by Drude's formula in the scattering process, on the basis of the initial values of the parameters relating to scattering, and the calculation formula stored in the memory unit, the arithmetic unit determining a state of a carrier after the scattering on the basis of a distribution function of a thermal equilibrium state.

According to a third aspect of the invention, there is provided a computer readable medium with a program which executes on a computer a Monte Carlo simulation method for simulating movement of a carrier by alternately repeating a scattering process and a drift process, comprising: causing the computer to calculate a scattering time by a Drude's formula in the scattering process; and causing the computer to determine a state of a carrier after the scattering on the basis of a distribution function of a thermal equilibrium state.

### BRIEF DESCRIPTION OF THE DRAWING

FIG. 1 schematically shows an N-channel MOSFET which is an object of simulation in a simulation method according to a first embodiment of the present invention;

FIG. 2 is a block diagram schematically showing the structure of a simulation apparatus according to the first embodiment of the invention;

FIG. 3 is a flow chart relating to the simulation method according to the first embodiment of the invention, and illustrating an ensemble Monte Carlo method in regions of an N-type source diffusion layer and an N-type drain diffusion layer of an N-channel MOSFET, which are not in a thermal equilibrium state;

FIG. 4 is a flow chart relating to the simulation method according to the first embodiment of the invention, and illustrating an ensemble Monte Carlo method in regions of the N-type source diffusion layer and N-type drain diffusion layer of the N-channel MOSFET, where most of the carriers are in quasi-equilibrium state;

FIG. 5 schematically shows a copper wire which is an object of simulation in a simulation method according to a second embodiment of the present invention;

FIG. 6 is a flow chart relating to the simulation method according to the second embodiment of the invention, and illustrating an ensemble Monte Carlo method for estimating a resistivity of a metal wire; and

FIG. 7 is a characteristic graph showing in comparison a simulation result and an actual measurement value of the film thickness dependency of the resistivity of the copper wire.

### DETAILED DESCRIPTION

Embodiments of the present invention will now be described with reference to the accompanying drawings.

In the simulation method according to the embodiments, the Monte Carlo method can be executed with only a few calibration parameters, such as the resistivity in single crystal of the material and the concentration of free carriers. These quantities are well known in various materials. Specifically, in the procedure of processing a scattering in the Monte Carlo method, a scattering time is determined by Drude's formula, and once carriers reached the scattering time, their state are transitioned to the thermal equilibrium state.

By this method, it becomes possible to omit a step of selecting scatterer, and a step of calculating a scattering frequency in each scattering process, which have been required in the conventional Monte Carlo method. It is thus unnecessary to individually treat the determination of a carrier state after scattering with respect to each scattering process. As a result, various scatterers, which determine the resistivity, can be integrated into only one scattering. Therefore, the calculation cost can be reduced, and the implementation can be made easy. This method is equivalent to solving a Boltzmann transport equation of relaxation time approximation, and can reproduce low-field carrier mobility.

Next, a detailed description is given of simulation methods, simulation apparatuses and programs of instructions for executing the simulation methods on computers, according to the respective embodiments of the present invention.

### First Embodiment

A first embodiment relates to an example of simulation of current-voltage characteristics in an N-channel MOSFET. In this example, the calculation cost can be reduced without lowering the precision of simulation.

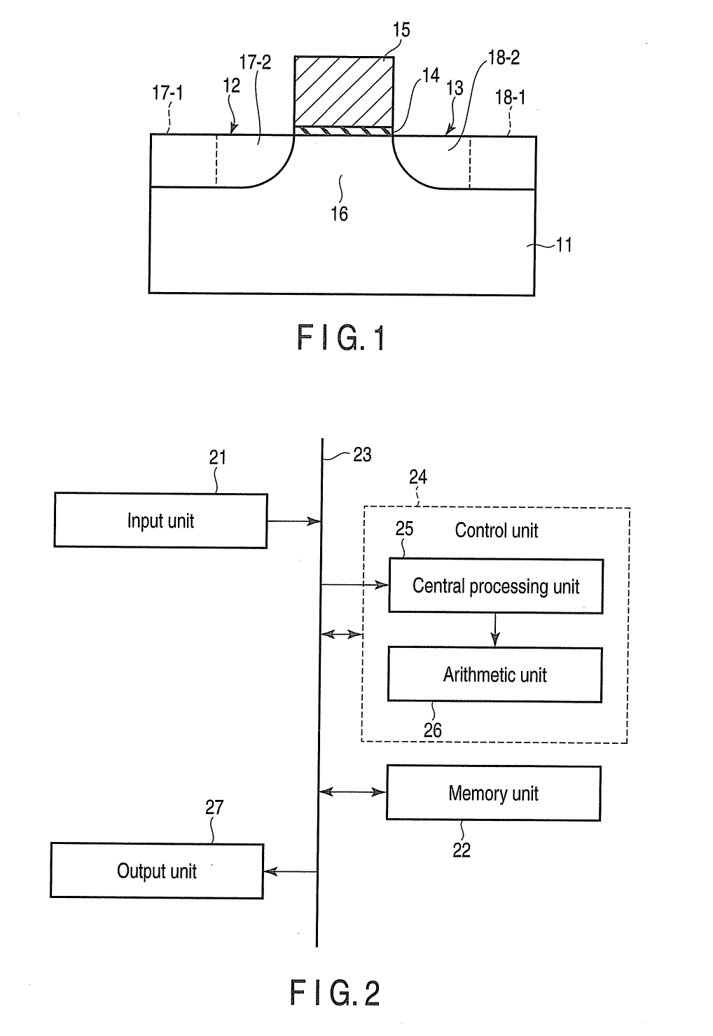

FIG. 1 is a schematic view of an N-channel MOSFET which is to be simulated. As shown in FIG. 1, in the N-channel MOSFET, an N-type source diffusion layer 12 and an N-type drain diffusion layer 13 are formed, spaced apart, in a surface region of a semiconductor substrate 11 such as a silicon substrate. A gate electrode 15 is formed via a gate insulation film 14 on a channel region between the diffusion layers 12 and 13.

Usually, many electrons as free carriers are present in the N-type source diffusion layer 12 and N-type drain diffusion layer 13, compared to a p-type substrate region 16 including a channel. In addition, many donor impurities are present in the N-type source diffusion layer 12 and N-type drain diffusion layer 13. Accordingly, the electrons in these diffusion layers frequently undergo ionized impurity scattering and electron-electron scattering. The ionized impurity scattering is generally known as an anisotropic scattering. In the Monte Carlo method, the calculation cost is higher in the process of an anisotropic scattering than in the process of an isotropic scattering. Thus, the total calculation time of the Monte Carlo simulation in the N-type MOSFET is mainly determined by the time of processing the motion of carriers in the N-type source diffusion layer 12 and N-type drain diffusion layer 13.

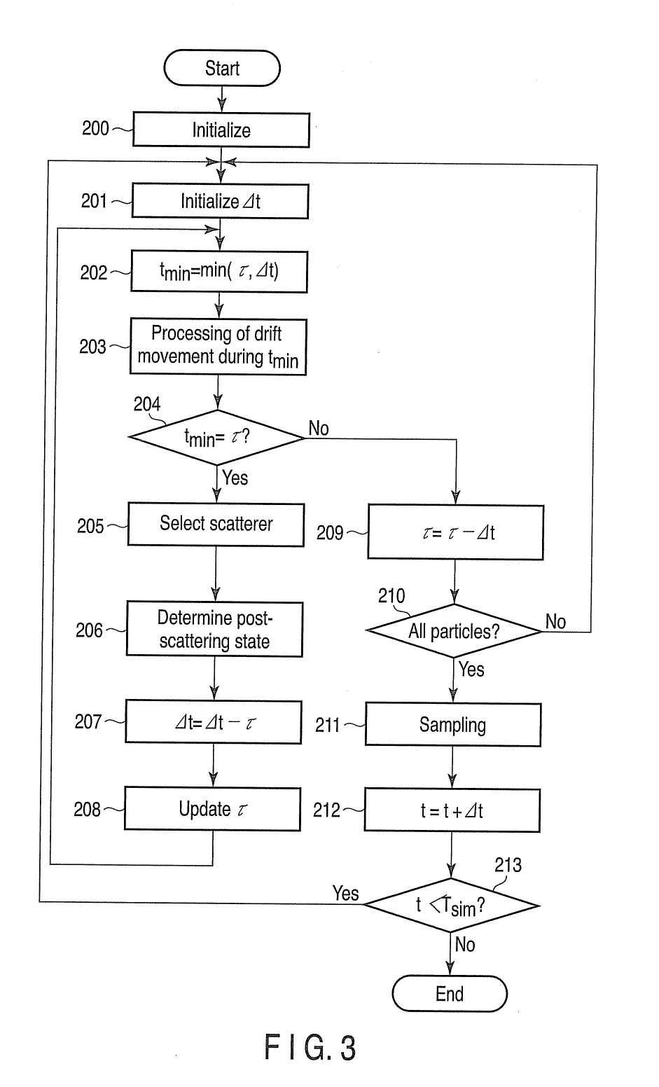

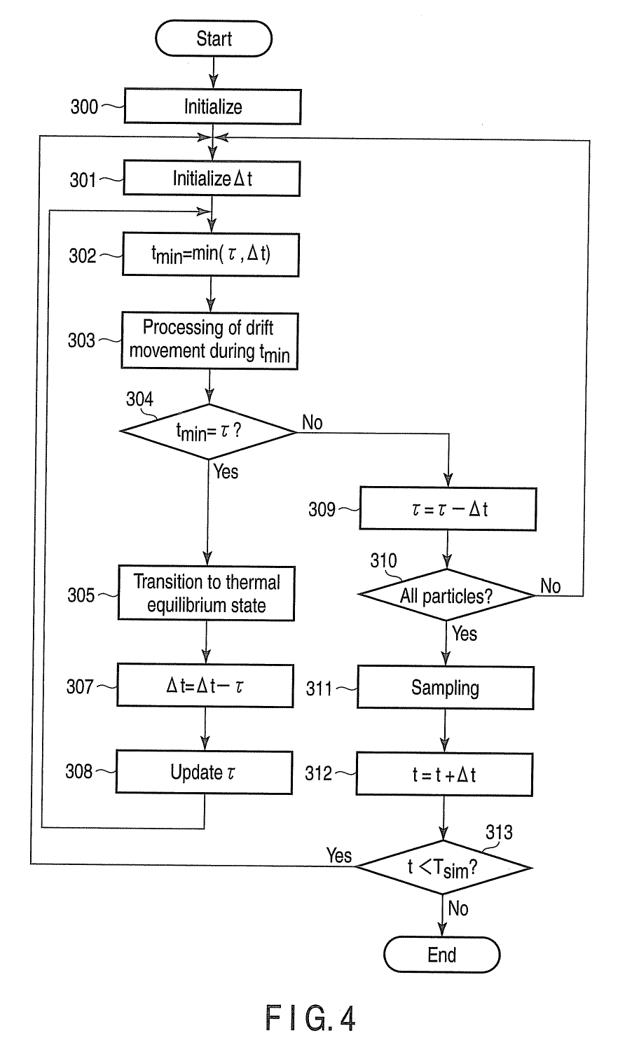

In the first embodiment, the reduction in cost is achieved by performing simplified calculation on the carriers which are present in partial regions of the source diffusion layer 12 and drain diffusion layer 13. Specifically, a simulation is performed by a simplified procedure, as illustrated in the flow chart of FIG. 4, with respect to a partial region (region 17-1 surrounded by a broken line) of the N-type source diffusion layer 12 and a partial region (region 18-1 surrounded by a broken line) of the N-type drain diffusion layer 13, which are considered to be always in nearly thermal equilibrium state under general bias conditions. With respect to the other regions 17-2 and 18-2 (regions close to the channel and gate electrode 15), calculation is performed by a procedure illustrated in the flow chart of FIG. 3, which is similar to the conventional procedure.

The above-described process procedures are switched when the carrier enters the region 17-1 or 18-1, or when the carrier goes out of the region 17-1 or 18-1.

A simulation apparatus shown in FIG. 2 comprises an input unit 21, a memory unit (memory) 22, a control unit 24 and an output unit 27. These units are configured to be connected by a signal transmission line such as a bus line 23. This simulation apparatus may be configured to be purpose-specific for simulation, or may be realized by associating the respective units of a computer. In the present embodiment, the description is mainly given of, by way of example, the case of using a personal computer.

The input unit 21 is composed of, for instance, a keyboard or a mouse, and the memory unit 22 is composed of, for instance, a hard disk or a semiconductor memory. The memory unit 22 stores in advance a program which is to be executed on the computer, for instance, a simulation program in which instructions of a process procedure for realizing the operations of the flow charts of FIG. 3 and FIG. 4 are described, and calculation formulae such as Drude's formula. In addition, the memory unit 22 stores the model formula of the device (MOSFET), the initial values of device parameters, and data such as parameters relating to various scatterers and various characteristics of the device. The memory unit 22 further stores a simulation result and, where necessary, data in the course of arithmetic operations.

The control unit 24 comprises, for example, a central processing unit (CPU) 25 and an arithmetic unit (ALU) 26, and these components are configured to control the arithmetic operations for simulation and the operations of the respective units. The output unit 27 is, for instance, a monitor or a printer, and may be a recording unit such as an external memory unit.

Next, referring to the flow charts of FIGS. 3 and 4, a detailed description is given of the Monte Carlo simulation by the simulation apparatus shown in FIG. 2. FIG. 3 illustrates a process procedure of the regions 17-2 and 18-2 which are not in the thermal equilibrium state in the N-type diffusion layer and N-type drain layer, and FIG. 4 illustrates a process procedure of the regions 17-1 and 18-1 where most of the carriers are in nearly thermal equilibrium state.

To start with, the input unit 21 inputs, for example, the model formula of the device, the initial values of device parameters, and data such as parameters relating to various scatterers and various characteristics of the MOSFET which are actually measured. The data are stored in the memory unit 22 via the bus line 23 under the control of the control unit 24, for example, in the hard disk within the personal computer. Needless to say, part of the data or all the data may be stored in advance in the memory unit 22.

These data are processed by the control unit 24 according to the simulation program, formulae and various calculation expressions, which are stored in the memory unit 22. Specifically, the data are transferred to the central processing unit 25 and arithmetic unit 26 in the control unit 24, and the simulation is executed according to the procedure illustrated in FIG. 3 or FIG. 4. When the carrier is present in the region 17-2 or 18-2, the simulation is executed according to the procedure shown in the flow chart of FIG. 3, which is similar to the prior art. When the carrier enters the region 17-1 or 18-1, the simulation is executed according to the procedure shown in the flow chart of FIG. 4. When the carrier does out of the region 17-1 or 18-1, the simulation is executed according to the procedure illustrated in the flow chart of FIG. 3.

A description is given of, by way of example, the case where the carrier moves from the region 17-2, 18-2 which is not in the thermal equilibrium state, to the region 17-1, 18-1 where most of the carrier in thermal equilibrium state.

As shown in FIG. 3, initialization is performed by inputting from the input unit 21 the conditions of the simulation, for instance, the materials of the respective parts of the MOSFET, the number of electrons, the initial disposal and state of electrons, the electric field that is applied, the surrounding environment, the initial values of parameters relating to scattering, and the sampling time (step 200). In addition, the central processing unit 25 controls the memory unit 22, so that the input data of the conditions are stored.

According to the program for executing the Monte Carlo simulation on the computer, which is stored in the memory unit 22, the arithmetic unit 26 performs arithmetic operations on the basis of the input conditions and data, and the simulation is started.

Subsequently, the arithmetic unit 26 initializes a variant Δt sampling time intervals which are given by the above input, and the initialized variant Δt is stored in the memory unit 22 via the bus line 23 (step 201).

Then, the arithmetic unit 26 finds a minimum time tₘᵢₙ on the basis of the initial values of the parameters relating to scattering (a time τ until electrons are scattered, and a time Δt until data sampling) (step 202). The calculated minimum time tₘᵢₙ is stored in the memory unit 22 via the bus line 23.

Thereafter, a process is executed to drift the particle (electron) only for the minimum time tₘᵢₙ. Specifically, using the arithmetic unit 26, the Newton's equation of motion is solved only during the time tₘᵢₙ (step 203). Then, it is determined whether the time τ until the electron is scattered has been reached (step 204). When the scattering time τ has been reached, the selection of the scatterer is executed (step 205), and the state after scattering is determined in accordance with the selected scatterer (step 206).

Next, the scattering time τ is subtracted from the Δt (step 207), and the scattering time τ is updated by the Drude's formula (step S208). The operations of steps 202 to 208 are repeated.

On the other hand, in the case where it is determined in step 204 that the scattering time τ has not been reached, the time Δt until sampling is subtracted from the scattering time τ (step 209), and it is determined whether the processes for all particles have been completed (step 210).

If it is determined that the processes for all particles have not been completed, the process of steps 201, 202, 203, 204 and 209 or the process of steps 201 to 208 are repeated.

If it is determined in step 210 that the processes for all particles have been completed, data sampling is performed (step 211) and information about the average velocity of all particles, etc. is found and stored in the memory unit 22. Subsequently, the sampling time Δt is added to the time t (step 212), and the above-described operation is repeated until the time t reaches the total simulation time Tₛᵢₘ (step 213). Thereafter, if the carrier enters the region 17-1 or 18-1, where most of the carriers are in a quasi-equilibrium state, the simulation is executed by the procedure shown in FIG. 4.

The difference between the procedure shown in FIG. 4 and the procedure shown in FIG. 3 is in the part relating to the scattering process (steps 205 and 206 in FIG. 3). Since the other steps 301 to 304 and 307 to 313 are substantially the same as steps 201-204 and 207 to 213, a detailed description is omitted.

In the procedure shown in FIG. 3, the scatterer is determined in step 205, and the carrier state after scattering corresponding to the scatterer is determined in step 206. However, in the procedure shown in FIG. 4, the scatterer is not determined, and when the scattering time has been reached, the carrier state after scattering is determined on the basis of the distribution function of the thermal equilibrium state (step 305). Specifically, using an algorithm called “rejection method”, the energy of the carrier is probabilistically determined by making use of quasi-random numbers, and the momentum vector is determined isotropically by using another quasi-random numbers.

Specifically, the step of determining a scatterer is unnecessary in the simulation of the regions 17-1 and 18-1 where carrier concentration is high and is considered to be substantially in the thermal equilibrium state, and the carrier state after scattering is always determined isotropically. Thereby, the calculation time of the carriers in the source and drain diffusion regions, which has been a bottle neck of the calculation time of the Monte Carlo simulation, can be decreased, and the speed of the simulation can be increased.

In step 308 of determining the scattering time τ, τ is determined by using a quasi-random number according to an exponential distribution having as a mean value the relaxation time <τ> given by the following Drude's formula:

$$〈 τ 〉 = \frac{m}{ρ {ne}^{2}} \qquad ( 1 )$$

where m is the effective mass of electron, ρ is the bulk resistivity of material, n is the bulk free electron concentration of material, and e is the elementary charge. In general, ρ and n are functions of positions. For example, as ρ and n, the value of bulk resistivity and the value of bulk electron density, which are averaged in the regions 17-1 and 18-1, can be adopted.

Next, a description of the influence on the simulation precision due to the above-described simplification is given. In the present method, after reaching the relaxation time given by the Drude's formula, carriers state are transited to thermal equilibrium state. This calculation guarantees that the distribution function of carriers reaches the equilibrium state in the relaxation time <τ>. In short, this method is equivalent to solving the Boltzmann transport equation of relaxation time approximation, which is shown in formula (2):

$$\frac{\partial f}{\partial t} + v \cdot {∇}_{r} f + \frac{F}{ℏ} {∇}_{k} f = - \frac{f - {f}_{0}}{〈 τ 〉} \qquad ( 2 )$$

where v is a carrier velocity, f is a distribution function of carriers, f₀ is a distribution function of a thermal equilibrium state, and F is a force acting on a carrier.

Accordingly, proper results are given with respect to a linear region where the electric field and drift velocity are in a proportional relationship, and a region where the shape of the distribution function is considered to be very close to a thermal equilibrium state. In other words, with respect to the partial region 17-1 of the N-type source diffusion layer 12 and the partial region 18-1 of the N-type drain diffusion layer 13, where most of the carriers in quasi-equilibrium state, the calculation cost can be reduced without degrading precision by executing the simulation in the procedure shown in FIG. 4.

If the simulation is finished as described above, the arithmetic (simulation) result by the arithmetic unit 26 is transferred and stored in the memory unit 22 via the bus line 23 by the control of the central processing unit 25. By the control of the control unit 24, the simulation result that is stored in the memory unit 22 is output from the output unit 27 such as a monitor or a printer.

According to the above-described structure and method, there can be provided a simulation method and a simulation apparatus which can reduce the difficulty in implementation and the calculation cost.

### Second Embodiment

A second embodiment of the invention, which relates to a simulation for estimating the resistivity of a metal wire, is described.

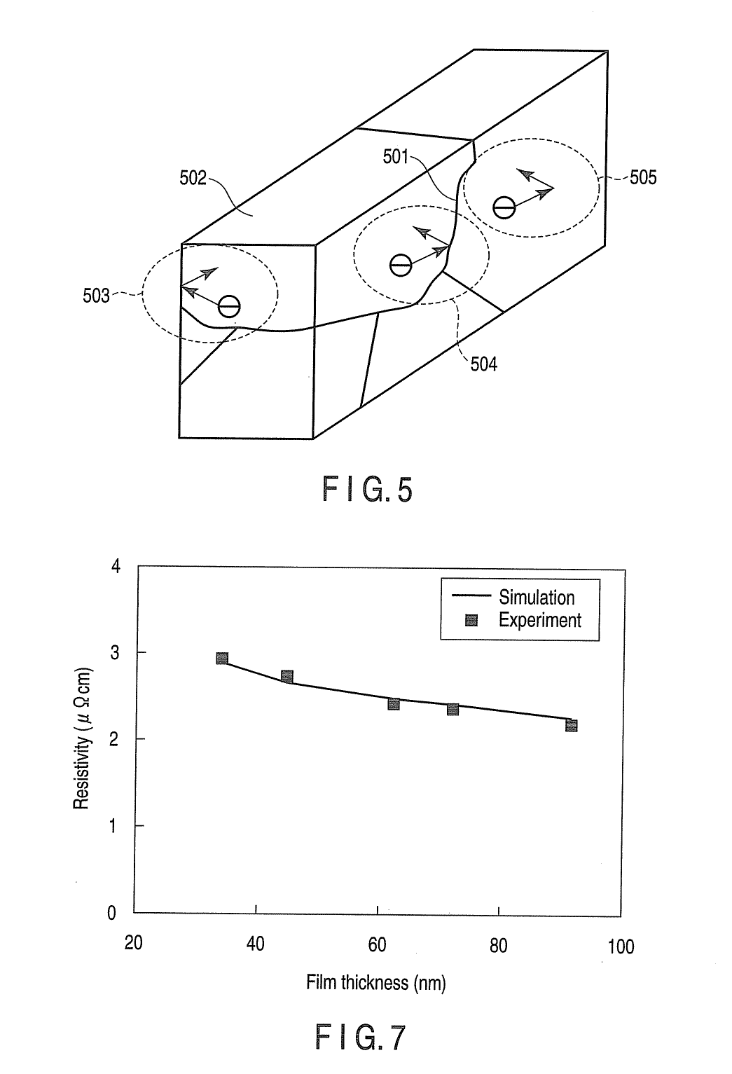

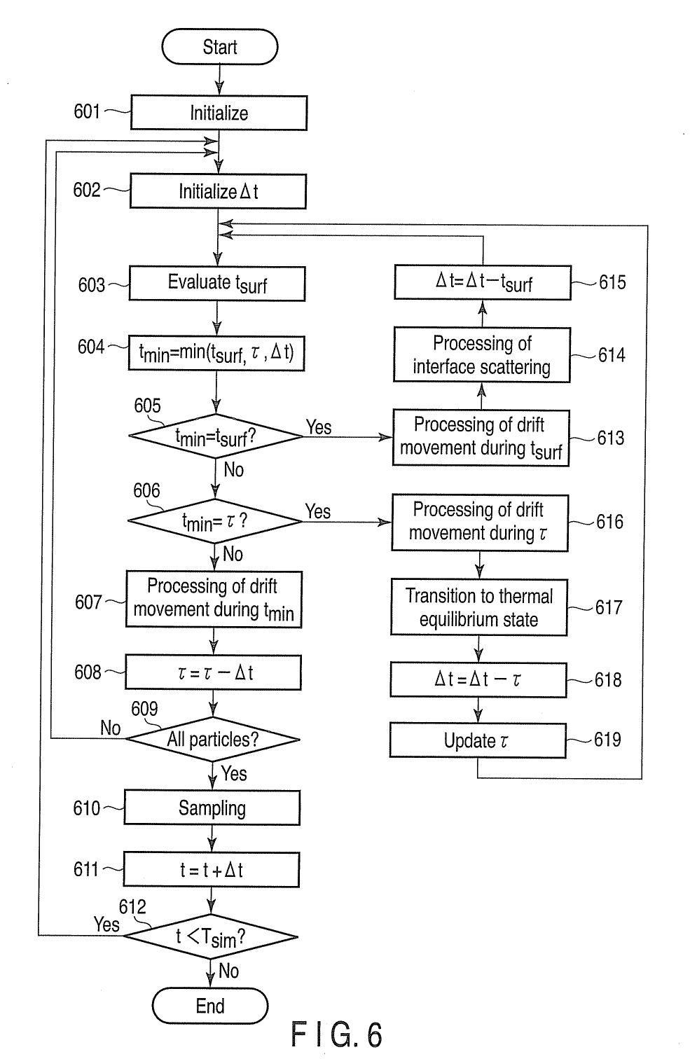

FIG. 5 is a schematic view showing a copper wire which is an object of simulation. FIG. 6 is a flow chart illustrating an ensemble Monte Carlo method for estimating the resistivity of a metal wire. FIG. 7 shows, as a simulation result, the film thickness dependency of the resistivity of the copper wire.

A copper wire shown in FIG. 5 is polycrystalline, and a grain boundary 501 is present in the copper wire. In this wire structure, as is conventionally known, a conduction carrier undergoes not only a phonon scattering, an impurity scattering and a carrier-carrier scattering 505, which are scattering mechanisms inherent in the material, but also scatterings occurring due to the structure, such as interface scattering (e.g. surface roughness scattering) at copper surface and a grain boundary scattering 504 at the grain boundary. If the wire is scaled down, the interface scattering increases. Also the size of the crystal grain decreases. So, the grain boundary scattering increases and the resistivity of the wire increases. This is called the size effect of resistivity. In the second embodiment, a description is given of an example of reproducing the size effect of resistivity of the metallic wire.

As shown in the flow chart of FIG. 6, when simulation is started, the conditions of the simulation, for example, the state of an electron regarded as a particle, which are input from the input unit 201, are initialized (step 601). In addition, the central processing unit 25 controls the memory unit 22, so that the input conditions are stored.

Next, according to the program for executing the Monte Carlo simulation on the computer, which is stored in the memory unit 22, the arithmetic unit 26 performs arithmetic operations on the input conditions and data stored in the memory unit 22, and the simulation is started.

Subsequently, the sampling time that is input from the input unit 21 is stored for the variant Δt, and the variant Δt is initialized (step 602). Then, a time t_{surf} until the particle reaches the interface is evaluated (step 603). In step 603, the time t_{surf} is calculated, for example, from the velocity vector of the carrier, the position of the carrier and the distance to the interface. The calculated time t_{surf} is stored in the memory unit 22 via the bus line 23 by the control of the central processing unit 25.

Next, that one of the time t_{surf} until reaching the interface, the time τ until scattering and the time Δt until sampling, which is the minimum time, is found by the arithmetic unit 26, and this time is set to be the minimum time tₘᵢₙ (step 604). This minimum time tₘᵢₙ is stored in the memory unit 22 via the bus line 23 by the control of the central processing unit 25.

Thereafter, the time tₘᵢₙ and the time t_{surf} are compared (step 605). As a result, if these times are equal, the particle makes drift movement during the time t_{surf}, and then interface scattering occurs. After the process of drift motion of time t_{surf} is executed by the control unit 24, the process of interface scattering is executed (step 613, 614). Then, the time t_{surf} is subtracted from the time Δt until sampling (step 615). This process corresponds to the advancement of the time instant of the particle.

On the other hand, in step 605, if the time tₘᵢₙ and the time t_{surf} are compared and are not equal, the time tₘᵢₙ and the time τ are compared (step 606). If the time tₘᵢₙ and the time τ are compared and are equal, the particle makes drift motion during the time τ, and scattering occurs in the bulk region. Thus, the process relating to the drift and scattering is executed (steps 616 to 619). Specifically, the process of drift motion during the time τ is executed (step 616), and the post-scattering state is determined on the basis of the distribution function of the thermal equilibrium state in the same manner as in the above-described step 305 (step 617). Then, the time τ is subtracted from the time Δt (step 168). Thereafter, the time τ is updated (step 619).

On the other hand, in step 606, if the time tₘᵢₙ and the time τ are compared and are not equal, this means that the particle has reached the sampling time, and thus the particle is caused to make drift movement only during the time tₘᵢₙ (step 607). Then, time Δt is subtracted from the time τ (step 608).

Thereafter, the processes for other particles begin, and the same process as described above is executed (steps 602 to 609).

The above process for all particles is finished, sampling is executed (step 610). The average velocity of all particles, for instance, is found and stored in the memory unit 22 as a simulation result. Then, the time t is incremented by the time Δt (step 611). Thereafter, it is determined whether the time t has reached the simulation time τₛᵢₘ (step 612). Until the time t reaches the simulation time τₛᵢₘ, the above-described process is repeated.

As has been described above, the scatterings of carriers, which occur in the metal wiring and need be taken into account in order to reproduce the size effect, are a phonon scattering, an impurity scattering and a carrier-carrier scattering, which determines the “bulk resistivity” of the metal material, and are an interface scattering and a grain boundary scattering, which cause the size effect of resistivity. In the second embodiment, the simulation method of the present invention is applied to the scattering mechanisms inherent in the material, which determine the bulk resistivity, such as the phonon scattering, impurity scattering and carrier-carrier scattering.

On the other hand, such an approach is adopted that the scattering mechanisms resulting from the structure, such as the interface scattering and grain boundary scattering, which cause the size effect, are regarded as scatterings occurring in drift movement and are incorporated in the drift mode.

Specifically, the relaxation time (scattering time) is determined with use of the bulk resistivity ρ and electron density n by making use of the Drude's formula, and the carrier which has reached the relaxation time is immediately made to transition to the thermal equilibrium state. The bulk resistivity is determined by the phonon scattering, impurity scattering and carrier-carrier scattering, and these effects are all integrated in the relaxation time that is obtained by the Drude's formula. The scattering mechanisms inherent in the material, which determine the bulk resistivity, such as the phonon scattering, impurity scattering and carrier-carrier scattering, are integrated into one scattering. In addition, the scattering mode occurring from the structure is incorporated in the scattering occurring in the drift mode. Thereby, the size effect can be considered.

Accordingly, in the second embodiment, the step of determining the seed of scattering, such as phonon scattering, impurity scattering or carrier-carrier scattering in the scattering mode, is not necessary, and the post-scattering state can be processed regardless of the seed of scattering. Therefore, the implementation is easy and the calculation cost can be reduced.

FIG. 7 shows in comparison a simulation result and an actual measurement value of the film thickness dependency of the resistivity of the copper wire. In FIG. 7, symbol [symbol] indicates an actual measurement result, and a solid line indicates a simulation result. FIG. 7 plots the resistivity under the condition that the line width is 500 nm and the temperature is 300 K. the simulation result corresponds to the actual measurement value, and the reproducibility relative to the actual measurement value is good.

As described above, it is possible to provide a simulation method and a simulation apparatus which can reduce the difficulty in implementation and the calculation cost, without degrading the reliability of simulation. In particular, it is difficult to simulate the carrier transport in a metal by the Monte Carlo method, and to calculate the resistance of the metal. Moreover, in the case of a polycrystalline material, the simulation is still more difficult owing to the presence of grain boundaries. However, according to the second embodiment, even in the case where scattering occurs due to grain boundaries, since the scattering can be processed by the part relating to the drift, the simulation can be performed with high precision.

In the first and second embodiments, the invention is applied to the carrier transport in the semiconductor and metal. However, if the resistivity and carrier concentration of the material are known, the invention is applicable to any seed of object of analysis. Specifically, if the concentration of particles and the resistivity relating to the flow of particles are known, the invention is applicable to the problems of the transport of carriers in a suicide that is a kind of alloy and the transport of atoms and molecules.

### Third Embodiment

If the program of the Monte Carlo simulation methods of the first and second embodiments is stored in a memory unit, such as a hard disk or a semiconductor memory, in a personal computer, and the program is executed, it becomes possible to realize a Monte Carlo simulator which can reduce the calculation cost without degrading the calculation precision, by using the personal computer.

In addition, it is possible to provide a computer-readable storage medium in which this program is stored.

As described above, the simulation method according to the embodiment of the invention is a Monte Carlo simulation method which simulates the movement of a carrier by alternately repeating a scattering mode and a drift mode. In the process of the scattering mode, the method comprises a step of calculating, as a scattering time, a relaxation time by Drude's formula, and a step of determining the state of a carrier, which has reached the scattering time, on the basis of a distribution function of a thermal equilibrium state.

According to this method, it is possible to perform a Monte Carlo simulation which reduces the calculation cost and implementation cost, without degrading the calculation precision of low-field mobility.

In the above method, the drift process includes a step of processing scatterings occurring due to a structure, including an interface scattering and a grain boundary scattering.

Thereby, it is possible to realize a Monte Carlo simulation which takes into account the degradation of mobility due to geometric structures, as in an interface scattering (e.g. surface roughness scattering) or grain boundary scattering.

Further, according to another aspect of the invention, there is provided a Monte Carlo simulation apparatus for simulating movement of a carrier by alternately repeating a scattering process and a drift process, the apparatus comprising an input unit configured to input initial values of parameters relating to scattering; a memory unit configured to store a simulation program, a calculation formula, a model formula of a device, the initial values of the parameters relating to scattering, which are input from the input unit, and an arithmetic result; an arithmetic unit configured to calculate, as a scattering time, a relaxation time by a Drude's formula in the scattering mode, on the basis of the initial values of the parameters relating to scattering, and the calculation formula stored in the memory unit, the arithmetic unit determining a state of a carrier, which has reached the scattering time, on the basis of a distribution function of a thermal equilibrium state; a processing unit configured to control the input unit and the arithmetic unit according to the simulation program stored in the memory unit; and an output unit configured to be controlled by the processing unit and to output a simulation result which is obtained by an arithmetic operation by the arithmetic unit.

Thereby, it is possible to realize a Monte Carlo simulator which reduces the calculation cost, without degrading the calculation precision of low-field carrier mobility.

In the above apparatus, the arithmetic unit further processes, in the processing of the drift process of carriers, scatterings occurring due to a structure, including an interface scattering and a grain boundary scattering.

According to this structure, it is possible to realize a Monte Carlo simulator which takes into account the degradation of mobility due to structures, as in the case of an interface scattering or grain boundary scattering, and which reduces the calculation cost.

According to still another aspect of the invention, there is provided a program for executing on a computer a Monte Carlo simulation method for simulating movement of a carrier by alternately repeating a scattering process and a drift process, the program comprising a procedure of calculating, as a scattering time, a relaxation time by Drude's formula in a part of processing the scattering process; and a procedure of determining a state of a carrier, which has reached the scattering time, on the basis of a distribution function of a thermal equilibrium state.

By executing the above program, it is possible to reduce the difficulty in implementation and the calculation cost, without degrading the reliability of simulation.

According to the above-described first to third embodiments, it is possible to provide a compact simulation method which reproduces a low-field carrier mobility by using physical quantities, such as a resistivity of bulk material and an free electron concentration, which are known in various materials. The resistivity and free electron concentration are quantities which can easily be known by experiments. Thus, it is also possible to perform a simulation of carrier transport in a new material, for instance, a metal to which the Monte Carlo method has not yet been applied. Besides, by determining the scattering time by the Drude's formula and determining the carrier state after scattering on the basis of the distribution function of the thermal equilibrium state of carriers, the difficulty in implementation and the calculation cost can be reduced without degrading the reliability of simulation.

### Fourth Embodiment

Next, a description is given of major steps of a method of manufacturing a semiconductor device according to the embodiment of the invention.

To start with, a device simulation is executed according to the above-described procedure. Device characteristic data, which has been obtained by this simulation, is referred to or taken into account when a device is actually manufactured by conducting various processes on a semiconductor wafer. A result of device evaluation relating to the actually manufactured device is fed back to the input data in the simulation. By making use of the simulation, it is possible to enhance the efficiency of the device design/development and the manufacturing method of the semiconductor device.

For example, in the manufacturing method of the semiconductor device according to an aspect of the embodiment, a Monte Carlo simulation is performed for simulating movement of a carrier by alternately repeating a scattering mode and a drift mode, the Monte Carlo simulation comprising a step of calculating, as a scattering time, a relaxation time by a Drude's formula in a process of the scattering mode, and a step of determining a state of a carrier, which has reached the scattering time, on the basis of a distribution function of a thermal equilibrium state. Then, on the basis of the device characteristic data obtained by the simulation, a semiconductor wafer is processed, and a semiconductor device is manufactured.

Further, after the semiconductor device is manufactured, the characteristics of the semiconductor device are measured. On the basis of the measured characteristics, it is possible to perform a Monte Carlo simulation for simulating movement of a carrier by alternately repeating a scattering mode and a drift mode, the Monte Carlo simulation comprising a step of calculating, as a scattering time, a relaxation time by a Drude's formula in a process of the scattering mode, and a step of determining a state of a carrier, which has reached the scattering time, on the basis of a distribution function of a thermal equilibrium state.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A Monte Carlo simulation method for simulating movement of a carrier by alternately repeating a scattering process and a drift process, comprising:
calculating a scattering time by Drude's formula in the scattering process; and
determining a state of a carrier after the scattering on the basis of a distribution function of a thermal equilibrium state.

2. The method of claim 1, wherein the simulation method processes, in a process of the drift mode of the carrier, scatterings occurring due to a structure, including an interface scattering and a grain boundary scattering.

3. A Monte Carlo simulation apparatus for simulating movement of a carrier by alternately repeating a scattering process and a drift process, comprising:
an input unit configured to input initial values of parameters relating to scattering;
a memory unit configured to store a simulation program, a calculation formula, a model formula of a device, the initial values of the parameters relating to scattering, which are input from the input unit, and an arithmetic result;
an arithmetic result; an arithmetic unit configured to calculate as a scattering time by Drude's formula in the scattering process, on the basis of the initial values of the parameters relating to scattering, and the calculation formula stored in the memory unit, the arithmetic unit determining a state of a carrier after the scattering on the basis of a distribution function of a thermal equilibrium state.

4. The apparatus of claim 3, wherein the arithmetic unit processes, in a process of the drift process of the carrier, scatterings occurring due to a structure, including an interface scattering and a grain boundary scattering.

5. A computer readable medium with a program which executes on a computer a Monte Carlo simulation method for simulating movement of a carrier by alternately repeating a scattering process and a drift process, comprising:
causing the computer to calculate a scattering time by a Drude's formula in the scattering process; and
causing the computer to determine a state of a carrier after the scattering on the basis of a distribution function of a thermal equilibrium state.

6. The medium of claim 5, wherein the simulation method processes, in the process of the drift process of the carrier, scatterings occurring due to a structure, including an interface scattering and a grain boundary scattering.

7. The method of claim 1, wherein the simulation method executes processing without determining a scatterer, in a case where the carrier is in a thermal equilibrium state.

8. The apparatus of claim 3, wherein the simulation executes processing without determining a scatterer, in a case where the carrier is in a thermal equilibrium state.

9. The medium of claim 5, wherein the simulation method executes processing without determining a scatterer, in a case where the carrier is in a thermal equilibrium state.

10. The method of claim 1, further comprising:
processing, in the drift process, scatterings occurring due to a structure, including an interface scattering and a grain boundary scattering.

11. The method of claim 2, wherein the simulation method processes a phonon scattering, an impurity scattering and a carrier-carrier scattering, which determine a resistivity of a bulk inherent in a material.

12. The apparatus of claim 4, wherein the arithmetic unit processes a phonon scattering, an impurity scattering and a carrier-carrier scattering, which determine a resistivity of a bulk inherent in a material.

13. The medium of claim 6, wherein the simulation method processes a phonon scattering, an impurity scattering and a carrier-carrier scattering, which determine a resistivity of a bulk inherent in a material.

14. The method of claim 1, further comprising processing the drift process on condition that the carrier carries out a drift movement, after determining the state of the carrier which has reached the scattering time.

15. The method of claim 1, wherein the carrier is movable between a first region which is in the thermal equilibrium state and a second region which is not in the thermal equilibrium state, said method further comprising:
determining the state of the carrier, which has reached the scattering time, on the basis of a distribution function of the thermal equilibrium state when the carrier exists in the first region, and
selecting a scatterer and performing a process based on the selected scatterer, when the carrier exists in the second region.

16. The method of claim 1, further comprising, storing a result of the determining the state of the carrier.

17. The method of claim 7, further comprising, storing a result of the determining the state of the carrier.

18. The method of claim 10, further comprising, storing a result of the determining the state of the carrier.

19. The method of claim 14, further comprising, storing a result of the determining the state of the carrier.

20. The method of claim 15, further comprising, storing a result of the determining the state of the carrier.
